(19) United States
(12) Patent Application Publication
(10) Pub. No.: US 2009/0242493 A1
(43) Pub. Date: Oct. 1, 2009

(54) METHOD AND APPARATUS FOR ROUTINE LIQUID TESTING FOR TOTAL DISSOLVED SOLIDS

(75) Inventors: Robert Samborn, Santa Monica, CA (US); Charles F. Lee, Venice, CA (US); Jin H. Lee, Los Angeles, CA (US); Yun-Ho Son, Seoul (KR)

Correspondence Address: PATENT VENTURE GROUP, 10788 CIVIC CENTER DRIVE, SUITE 215, RANCHO CUCAMONGA, CA, 91730, US

(73) Assignee: HM DIGITAL, INC., Culver City, CA (US)

(21) Appl. No.: 12/055,131

(22) Filed: Mar. 25, 2008

(51) Int. Cl. B01D 37/04; G01N 27/00; C02F 1/00

(52) U.S. Cl. 210/767; 210/600; 210/746; 210/85

(57) ABSTRACT

An invention is provided for encouraging routine testing for TDS levels in a liquid. The invention includes determining a TDS level of the liquid utilizing an apparatus capable of determining a TDS level based on the conductivity of the liquid. Next, corrective action can be performed to reduce the TDS level when the TDS level is beyond a predetermined level. To facilitate a continual visual reminder for future TDS level testing, the apparatus is removably attached to a surface viewable when in proximity of a device utilized to access the liquid utilizing an integrated attachment mechanism.

### CROSS REFERENCE TO RELATED APPLICATIONS

This application is related to U.S. patent application having Ser. No. ______ (Attorney Docket No. HMDIP002), filed on Mar. 25, 2008, and entitled “Timing Based Method and Apparatus for Monitoring Drinking Water Purity and Encouraging Routine Testing of Drinking Water Purity,” which is hereby incorporated by reference.

### BACKGROUND OF THE INVENTION

1. Field of the Invention

This invention relates generally to liquid testing, including, but not limited to, water quality testing, and more particularly to testing for total dissolved solids (TDS) utilizing a portable TDS meter having properties that stimulate and encourage routine testing.

2. Description of the Related Art

When supplying or utilizing water for human consumption, water generally is maintained at a particular level of purity in order to ensure safe drinking water for humans and animals. In addition, alternate levels of water purity must be maintained for plants, fish, pipes and many industrial, pharmaceutical and medical applications. One means for measuring the purity of an aqueous substance, such as drinking water, is a measure of the total dissolved solids (TDS) in the liquid. TDS is a measure of the total amount of mobile charged ions, such as minerals, salts, and metals dissolved in a liquid, and often is expressed as parts per million (ppm). The lower the TDS level in water, the purer that water is. For example, water with a TDS level of 0 ppm is pure H₂O. Lower levels of TDS in drinking water allow cells to hydrate more efficiently when consumed by the human body. Conversely, high levels of TDS in drinking water increase the probability of harmful contaminants that may increase health risks or hinder absorption of water molecules on a cellular level. TDS also will directly affect the taste of water, generally making it unpleasant to the average person.

In response to the increased risks presented by high TDS levels in water for human consumption, TDS meters have been developed that provide a means to measure the TDS level of a liquid. In general, two principal methods have been utilized in TDS meters to measure the TDS level of a liquid: gravimetric methods and electrical conductivity methods. Gravimetric methods evaporate the liquid solvent leaving a residue that is weighed. Although generally very accurate, gravimetric methods can have problems when large proportions of the TDS consists of organic chemicals having a low boiling point that can evaporate along with the water. Additionally, gravimeters are cumbersome and cost prohibitive for the average, non-scientific user.

Since electrical conductivity of water is directly related to the concentration of dissolved ionized solids in the water, the electrical conductivity method often is utilized by TDS meters. Ions from dissolved solids in the water create the ability for water to conduct electric current. Hence, this electric current can be measured using a conductivity meter. Since pure H₂O has a conductivity of zero, the TDS level of a liquid can be calculated by converting the electrical conductivity using a particular factor into a TDS reading, generally in ppm. A TDS meter utilizing the electrical conductivity method provides a low-cost, easy-to-use mechanism for measuring overall water quality.

In use, an electrical conductivity-based TDS meter first is inserted into the liquid to be tested. The meter then samples the electrical conductivity of the liquid, generally utilizing an electrical conductivity sensor. Thereafter, the electrical conductivity of the liquid is converted to a TDS reading, generally in ppm. Once the TDS level of the liquid is known, the liquid may be subsequently utilized, or appropriate measures may be taken to correct the TDS level, most commonly reduced with a water purifier or filter for drinking water for human consumption. In certain circumstances, such as for plants or fish, the TDS level may need to be increased to accommodate the species' needs.

Typically, a substance must be routinely tested to ensure the proper level of TDS in the liquid is maintained. For example, when monitoring drinking water, the drinking water from a particular source should be routinely tested to ensure proper levels of TDS in the water are maintained. Unfortunately, most consumers do not routinely test their drinking water for TDS levels.

For example, when monitoring tap water, a consumer may obtain a TDS meter and test the TDS level of the tap water. At this point, a decision is generally made whether to correct the TDS level using a water purifier or filter, or to continue drinking the tap water. However, once the consumer has tested the TDS level of tap water, the consumer generally stores the TDS meter out of sight. The out of sight storage of the TDS meter then leads to the consumer forgetting to continue testing the water source or the filtration system that has since been installed. Because the TDS meter is not readily available, the consumer generally does not take the time to retrieve the TDS meter and perform future water tests. In general, every type of water purification or filtration system requires routine maintenance and filter replacement, and the TDS levels of tap water fluctuates daily with precipitation, weather and pipe conditions. Often, as mentioned above, the consumer forgets to test the water source because the TDS meter is stored out of sight. Consequently, if a filter or other means of maintaining low TDS levels in the liquid is applied, overtime the TDS level of the product water generally increases due to a decrease in the effectiveness of the filtration system. As a result, the high levels of TDS in the drinking water increase the probability of harmful contaminants that may affect taste, increase health risks, or hinder absorption of water molecules on a cellular level.

In view of the foregoing, there is a need for methods and apparatuses that encourage routine testing of liquids. The methods and apparatuses should encourage routine testing without being overly burdensome for the user. In addition, methods and apparatuses should provide this encouragement without undue increased costs in the manufacture of the TDS meter.

### SUMMARY OF THE INVENTION

Broadly speaking, embodiments of the present invention address these needs by providing a portable total dissolved solids (TDS) meter having properties that encourage and stimulate routine testing by the user. These properties discourage concealed storage of the apparatus that can lead to non-testing due to forgetfulness of the user. For example, in one embodiment, an apparatus for encouraging routine testing for total dissolved solids in liquids is disclosed. The apparatus includes a conductivity sensor capable of sensing a conductivity level of a liquid. In electrical communication with the conductivity sensor is a processor having logic that calculates a TDS level for the liquid based on the conductivity level of the liquid. In addition, a display is included that is in electrical communication with the processor, and that displays the calculated TDS level for the liquid. To encouraging routine testing for total dissolved solids, an integrated attachment mechanism is included that is capable of removably attaching the apparatus to a surface. For example, the attachment mechanism can be a magnet capable of removably attaching the apparatus to a metallic surface. In this case, the processor can be coated with a material, such as a dielectric material, capable of preventing damage caused by proximity to the magnet.

A method for encouraging routine testing for TDS levels in a liquid is disclosed in an additional embodiment of the present invention. The method includes determining a TDS level of the liquid utilizing an apparatus capable of determining the TDS level for the liquid based on a conductivity of the liquid. Next, corrective action is performed to reduce the TDS level when the TDS level is beyond a predetermined level. Then, to facilitate a continual visual reminder for future TDS level testing, the apparatus is removably attached to a surface viewable when in proximity of a device utilized to access the liquid. As above, the apparatus can be attached to the surface utilizing an attachment mechanism in the form of a magnet capable of removably attaching the apparatus to a metallic surface. The surface, for example, can be the surface of a refrigerator viewable when in proximity of a device utilized to access the liquid. Another exemplary surface can be the surface of a water filtration system viewable when in proximity of a device utilized to access the liquid. An example of corrective action can be changing a filter of a water filtration system utilized to filter the liquid. Here, additional filter analysis can comprise 1) determining the TDS level of the liquid prior to filtration, 2) determining the TDS level of the liquid subsequent to filtration, and 3) calculating an effectiveness of the filter based on the TDS level of the liquid prior to filtration and the TDS level of the liquid subsequent to filtration.

In a further embodiment, a TDS meter for determining total dissolved solids in liquids is disclosed. The TDS meter includes a housing having a length in the range of about four inches to twelve inches and a width in the range of about one half inch to two inches, thus making the TDS meter extremely portable. In addition, as above, the TDS meter includes a conductivity sensor disposed at least partially within the housing, and capable of sensing a conductivity level of a liquid. A processor is also included that is disposed within the housing and in electrical communication with the conductivity sensor. The processor includes logic that calculates a TDS level for the liquid based on the conductivity level of the liquid. As above, a display is includes that is in electrical communication with the processor, and that is capable of displaying the calculated TDS level for the liquid to a user. Further disposed within the housing is an integrated attachment mechanism capable of removably attaching the apparatus to a surface. As above, the attachment mechanism can be a magnet capable of removably attaching the apparatus to a metallic surface. In this case, the attachment mechanism can be configured to have a gauss rating such that the attachment mechanism holds the apparatus in place when removably attached to a vertical metallic surface, while further allowing the apparatus to be removed from the metallic surface without damaging the metallic surface.

In this manner, embodiments of the present invention advantageously encourage routine and continued testing for TDS by providing a mechanism for storage of the TDS testing apparatus in view of users when accessing their water. By providing an attachment mechanism having a gauss rating such that the attachment mechanism holds the apparatus in place when removably attached to a vertical metallic surface such as the surface of a refrigerator, embodiments of the present invention provide a constant reminder to the user to test TDS levels. Moreover, the user also avoids the need to search for the TDS apparatus and retrieve the apparatus from an inconvenient storage location. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing major components of a portable apparatus for determining total dissolved solids (TDS) in a liquid and encouraging routine use, in accordance with an embodiment of the present invention;

FIG. 2 is a diagram illustrating an exemplary arrangement of components in a front area and a back area of the apparatus, in accordance with an embodiment of the present invention;

FIG. 3 is a block diagram showing a functional flow of the apparatus for testing TDS levels, in accordance with an embodiment of the present invention; and

FIG. 4 is a flowchart showing a method for encouraging routine testing of liquid TDS levels in a home or office water system, in accordance with an embodiment of the present invention.

### DETAILED DESCRIPTION OF THE PREFERRED EMBODIMENTS

An invention is disclosed for encouraging the use of a total dissolved solids (TDS) meter for testing liquid purity. Broadly speaking, embodiments of the present invention provide this functionality by affording a portable TDS meter having properties that encourage and stimulate routine testing by the user. These properties also discourage concealed storage of the apparatus that can lead to non-testing due to forgetfulness of the user.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

As mentioned previously, when an average consumer utilizes a TDS meter to test the TDS levels of a liquid, the test generally is only performed once. This is because the average user is not reminded of the need for continued testing of the liquid for TDS levels. However, it is encouraged by professionals in the water quality industry that TDS testing be done on a weekly basis. Embodiments of the present invention address this issue by providing an apparatus for TDS testing that provides a reminder to the user to continue testing liquids for TDS levels. In one embodiment, this reminder is provided by keeping the apparatus in view of the user when not in use. Since the apparatus is in continued view of the user, the user is frequently reminded by the sight of the apparatus to test TDS levels.

However, as will be apparent to those skilled in the art, once a TDS meter has been utilized it needs to be stored until the next use. Unfortunately, prior art TDS meters generally only facilitated storage in out of sight areas, such as closets, drawers, and cupboards. Fortunately, embodiments of the present invention allow convenient storage of the apparatus in such a manner so as to keep the apparatus in view of the user, yet also stored in a safe area. Embodiments of the present invention provide such in sight storage via an integrated attachment mechanism that allows the apparatus to be removably attached to a vertical metallic surface, such as a refrigerator. In this manner, when not in use the apparatus can be stored within sight of the user, yet out of the way so as to not interfere with other areas of the room.

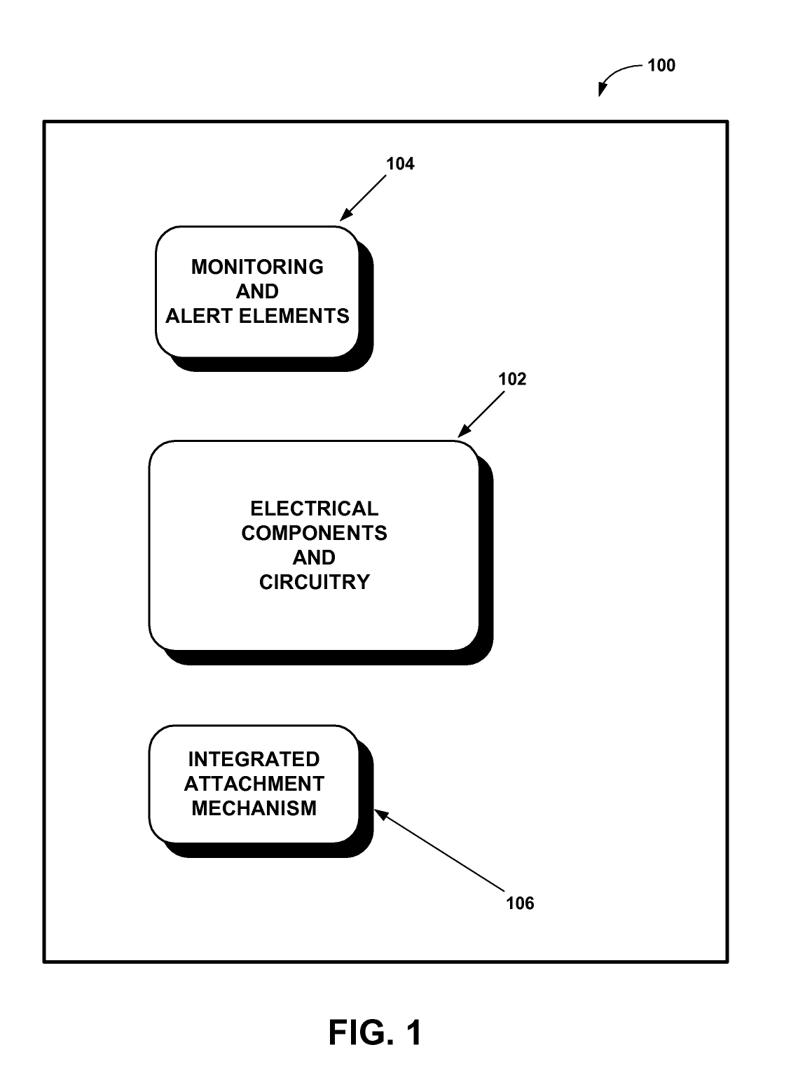

FIG. 1 is a block diagram showing major components of a portable apparatus 100 for determining total dissolved solids (TDS) in a liquid and encouraging routine use, in accordance with an embodiment of the present invention. The apparatus 100 includes electrical components and circuitry 102, monitoring and alert elements 104, and an attachment mechanism 106. As will be described in greater detail subsequently, the electrical components and circuitry 102 of the apparatus 100 are utilized to determine the TDS level of a liquid such as water utilizing a determination of the conductivity of the liquid. The monitoring and alert elements 104 are utilized to display the TDS level determination to a user and to alert the user to testing times for TDS testing, as described in co-pending U.S. application Ser. No. ______(Attorney Docket No. HMDIP002), entitled “Timing Based Method and Apparatus for Monitoring Drinking Water Purity and Encouraging Routine Testing of Drinking Water Purity,” filed Mar. 25, 2008, which is incorporated herein by reference in its entirety. The integrated attachment mechanism 106 provides in sight storage that allows the apparatus to be removably attached to a vertical metallic surface, such as a refrigerator.

As will be described in greater detail subsequently, the apparatus 100 determines the TDS of a liquid by measuring the electrical conductivity of a liquid, such as water. In general, embodiments of the present invention estimate the TDS Level based on the conductivity level of the liquid. That is, once the conductivity level of the liquid is determined, the electrical components and circuitry 102 determine the TDS Level by converting the measured conductivity into a TDS Reading which is displayed by the monitoring and alert elements 104. To increase accuracy in determining the TDS level from the conductivity level, one embodiment of the present invention accounts for different liquid mediums by utilizing different conversion factors based on the liquid medium being tested.

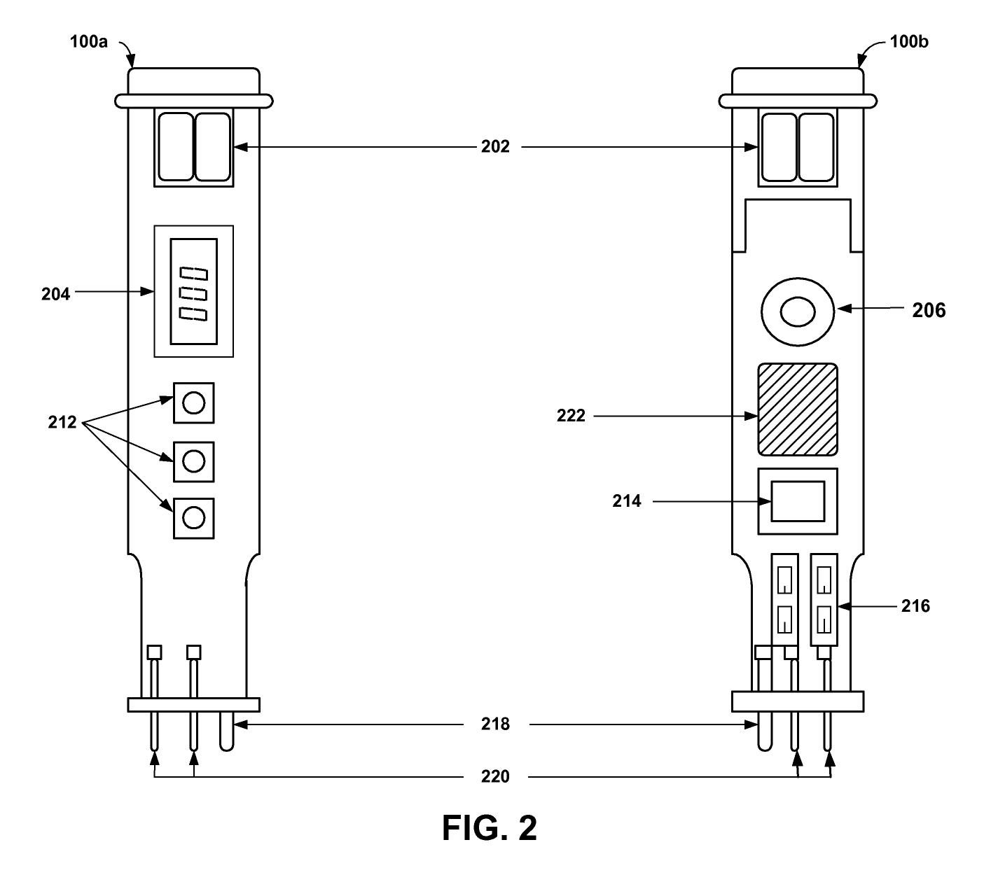

FIG. 2 is a diagram illustrating an exemplary arrangement of components in a front area 100a and a back area 100b of the apparatus, in accordance with an embodiment of the present invention. As illustrated in FIG. 2, disposed in the front area 100a of the exemplary arrangement are batteries 202, a liquid crystal display (LCD) display 204, user controls 212, a thermistor 218, and the conductivity sensor pins 220 of the conductivity sensor. Disposed in the back area 100b of the exemplary arrangement are the batteries 202 (which are also visible from the front area 100a), a speaker 206, an integrated attachment mechanism 222, a processor 214, conductivity circuitry 216, and the thermistor 218 and sensor pints 220 (which are also visible from the front area 100a).

In general, the above components can be disposed on a circuit board to provide necessary electrical connections. Power for the apparatus can be provided by way of a DC voltage power source in the form of two Silver Oxide or Lithium batteries 202, which provide power to all electrical components disposed on the circuit board. The LCD display 204 provides a visual means to view pertinent information generated by the processor 214, such as calculated TDS level readings and helpful alert messages. The speaker 206 provides a mechanism for providing audible alerts to a user, such as audible indications that the apparatus has been powered on, powered off, or other audible alerts. The user controls 212, for example micro switches, provide a means for users to enter commands and data into the apparatus, such as power on and off commands, data hold commands, temperature readings, changing modes, programming, checking temperature, performing digital calibration, and other processor directives as will be apparent to those skilled in the art after a careful reading of the present disclosure.

Because the conductivity of a liquid is affected by temperature, the apparatus includes a thermistor 218. The thermistor 218 serves to calibrate the apparatus based on the temperature of the liquid in which the apparatus is inserted. Broadly speaking, the thermistor 218 is a resistor having a resistance that varies with the temperature of the liquid in which it is submerged. In this manner, the thermistor 218 provides a mechanism to determine a temperature compensator coefficient to the processor 214 for TDS level calculation. The sensor pins 220, used in conjunction with the thermistor 218, provide a mechanism to determine the conductivity of the liquid in which they are submerged. In one embodiment, the sensor pins 220 are constructed from a lower resistance material such as copper, aluminum, graphite, or platinum, which provides a low resistance to the flow of electric current and serves as a carrier for the electric current when submerged in a test sample of a liquid.

In one embodiment, the components of the apparatus are disposed in a housing that encloses the batteries 202, speaker 206, processor 214, conductivity circuitry 216, and attachment mechanism 222, while partially enclosing the thermistor 218 and conductivity sensor pins 220 of the conductivity sensor. The LCD display 204 and user controls 212 can be provided on the outside of the housing allowing viewing and manipulative access to the user. Preferably, the apparatus 100 has a length in the range of about four inches to twelve inches and a width in the range of about one half inch to two inches, whereby the apparatus is portable. In this manner, the apparatus 100 can be easily handled by the user and stored in a convenient location, such as attached to the surface of the refrigerator utilizing the attachment mechanism as discussed subsequently.

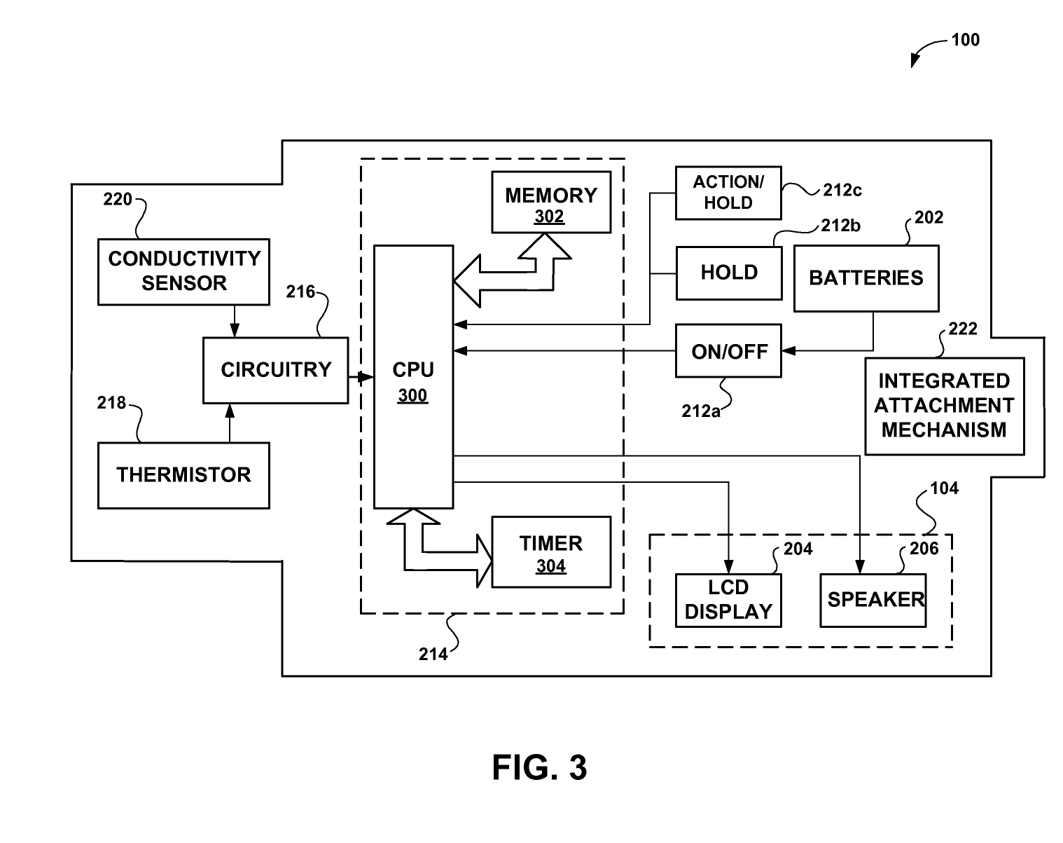

FIG. 3 is a block diagram showing a functional flow of the apparatus 100 for testing TDS levels, in accordance with an embodiment of the present invention. As shown in FIG. 3, the apparatus 100 includes a conductivity sensor 220 and thermistor 218 in communication with the processor 214 via circuitry 216. The processor 214 can include, for example, a CPU 300 in electrical communication with a memory 302 and an optional timer 304. The processor 214 further is in electrical communication with user controls, such as an on/off control 212a, a hold control 212b, and an action/program control 212c. The on/off user control 212a also controls current from the batteries 202 to the remainder of the apparatus components. In addition, the processor 214 is in communication with the LCD display 204 and speaker 206. Further, an integrated attachment mechanism 222 is included that allows the apparatus to be removably attached to a vertical metallic surface, such as a refrigerator.

In operation, an end of the apparatus 100 is inserted into a sample of a liquid to be tested. More specifically, the apparatus 100 is inserted into the sample such that the conductivity sensor 220 (i.e., the sensor pins) and the thermistor 218 are submerged in the liquid sample. The submerged sensor pins of the conductivity sensor 220 sense the degree of electrical conductivity present in the liquid or water. To some degree, most elements other than hydrogen and oxygen conduct electricity. Thus, the conductivity of the liquid can be utilized to determine the TDS level of the liquid. A signal from the conductivity sensor 220 and the thermistor 218 is provided to the CPU 300 of the processor 214 via circuitry 216, generally comprising discrete components on a circuit board. Once the signal is received, the CPU 300 calculates a TDS reading based on the signals from the conductivity sensor 220 and the thermistor 218. The calculated TDS reading then is displayed on the LCD display 204. As mentioned above, the CPU 300 of the processor 214 utilizes the signal from the thermistor 218 to calibrate the calculated TDS reading based on the temperature of the liquid.

As noted previously, embodiments of the present invention encourage and stimulate routine testing by the user by providing in sight storage via the integrated attachment mechanism 222 allowing the apparatus 100 to be stored within sight of the user, discouraging concealed storage of the apparatus that can lead to non-testing due to forgetfulness of the user.

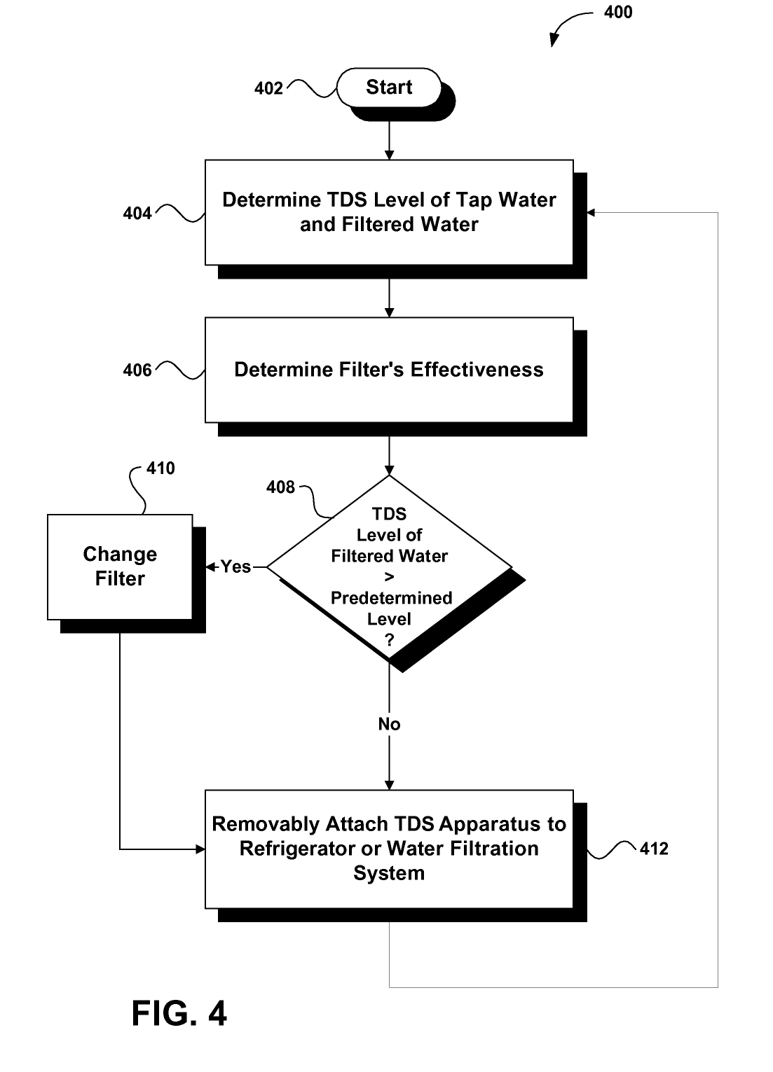

FIG. 4 is a flowchart showing a method 400 for encouraging routine testing of liquid TDS levels in a home or office water system, in accordance with an embodiment of the present invention. Specifically, method 400 illustrates a process for determining when a filter in a water filtration system should be changed to maintain a particular level of water purity utilizing an apparatus in accordance with an embodiment of the present invention. Although the following discussion of method 400 will be described in terms of water filtration, it should be noted that the apparatus 100 for TDS level testing of the embodiments of the present invention can be utilized for TDS testing in any environment, such as general water study, filter design, and other applications that will be apparent to those skilled in the art after a careful reading of the present disclosure.

In an initial operation 402, preprocess operations are performed. Preprocess operations can include, for example, determining a maximum TDS level desired for the liquid being tested, determining and installing proper filters when used in conjunction with a water filtration system, and other preprocess operations that will be apparent to those skilled in the art after a careful reading of the present disclosure.

In operation 404, the TDS level of the tap water and the filter water is determined. Embodiments of the present invention can be utilized to determine when the useful life of a filter is over and the filter should be changed. By analyzing the TDS level of water before and after the water has been filtered, embodiments of the present invention can determine when the filter is no longer filtering a desired level of TDS from the liquid, and thus when the life of the filter is over. Thus, in operation 404, the TDS level of the tap water and the filter water is determined by inserting the TDS apparatus 100 into a sample of the filtered water and unfiltered tap water.

For example, the apparatus 100 can be inserted into a sample of the filtered water such that the conductivity sensor 220 (i.e., the sensor pins) and the thermistor 218 are submerged in the sample. The submerged sensor pins of the conductivity sensor 220 sense the degree of electrical conductivity present in the liquid or water, and signals from both the conductivity sensor 220 and the thermistor 218 are provided to the processor 214. Once the signals are received, the processor 214 calculates a TDS reading based on the signals from the conductivity sensor 220 and the thermistor 218. The calculated TDS reading then is displayed on the LCD display 204. The apparatus 100 can then be removed from the sample of filtered and inserted into a sample of the unfiltered tap water and the above testing process repeated to determine the TDS level of the unfiltered tap water.

Once the TDS level of both the unfiltered tap water and filtered water is determined, the effectiveness of the filter can be determined in operation 406. Although optional, operation 406 allows the effectiveness of the filter to be determined based on the difference between TDS levels of the liquid before and after filtering. Although this determination is not necessary to determine when to change a filter, in this manner a user can compare filter effectiveness of different filters.

A decision is then made as to whether the TDS level of the filtered water is greater than a predetermined level, in operation 408. As discussed above, a maximum desired TDS level for the liquid being tested is determined. The maximum desired TDS level then becomes the predetermined level of the method 400. If the TDS level of the filtered water is greater than a predetermined level, the method 400 branches to operation 410. Otherwise, the method 400 continues to operation 412.

When the TDS level of the filtered water is greater than a predetermined level the filter is no longer filtering the water as desired. Thus, in operation 410, the current filter is removed from the water filtration system and a new filter is installed. In this manner, the life of a filter can be extended or bad filters can be spotted early. In general, filter manufactures estimate the useful life of a filter in terms of a particular period of time the filter can be utilized. However, the estimated useful life is not always correct. For example, when not in constant use, a filter's useful life may be much longer than a manufacture's estimate. Conversely, if used more than estimated, the filter's useful life may be much shorter than the manufacture's estimate. Thus, embodiments of the present invention can be utilized to more accurately determine when a filter is no longer performing as desired and should be changed.

Once testing is completed, the TDS apparatus 100 of the embodiments of the present invention is attached to a refrigerator or water filtration system in constant sight when in the room as a constant reminder to test the TDS level of the liquid, in operation 412. As noted previously, embodiments of the present invention encourage and stimulate routine testing by providing in sight storage via the integrated attachment mechanism 222. In this manner, the apparatus 100 can be stored within sight of the user, discouraging concealed storage of the apparatus that can lead to non-testing due to forgetfulness of the user.

In one embodiment, the attachment mechanism 222 is a magnet designed to fit within the housing that encloses the processor and a portion of the conductivity sensor. Moreover, the magnet is designed to have a gauss rating that allows the apparatus to be removably attached to a metallic surface and removed from the metallic surface without damaging the metallic surface. Furthermore the magnet has a gauss rating such that other components of the apparatus are not adversely affected by the magnet. Thus, the magnet of the attachment apparatus can be either bipolar or unipolar. Bipolar magnets have repeatable north/south polarity on the same side of the magnet, while unipolar magnets are have the magnetic poles located on different sides of the magnet. In addition, to further protect the processor and circuitry from the damaging effects from the magnetic field, embodiments of the present invention can coat the processor and circuitry with a material capable of preventing damage caused by proximity to the magnet. For example, in one embodiment, the processor and circuitry is coated with a dielectric material, such as silicone, acrylic, urethane, and epoxy designed to conform to the surface of the processor and circuitry.

Once the TDS apparatus 100 is attached to a visible surface in constant sight, the apparatus can again be utilized to perform additional TDS level determination in another operation 404 when needed. As mentioned above, since the TDS apparatus 100 is stored in sight of the user each time the user accesses the water, the user is constantly reminded to retest the water periodically. Thus, embodiments of the present invention advantageously encourage routine and continued testing for TDS by providing a mechanism for storage of the TDS testing apparatus in view of users when accessing their water. By providing an attachment mechanism having a gauss rating such that the attachment mechanism holds the apparatus in place when removably attached to a vertical metallic surface such as the surface of a refrigerator, embodiments of the present invention provide a constant reminder to the user to test TDS levels. Moreover, the user also avoids the need to search for the TDS apparatus and retrieve the apparatus from an inconvenient storage location.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An apparatus for determining total dissolved solids in liquids, comprising:
a conductivity sensor capable of sensing a conductivity level of a liquid;
a processor in electrical communication with the conductivity sensor, the processor having logic that calculates a total dissolved solids (TDS) level for the liquid based on the conductivity level of the liquid;
a display in electrical communication with the processor, the display capable of displaying the calculated TDS level for the liquid; and
an integrated attachment mechanism capable of removably attaching the apparatus to a surface.

2. An apparatus as recited in claim 1, wherein the attachment mechanism is a magnet capable of removably attaching the apparatus to a metallic surface.

3. An apparatus as recited in claim 2, wherein the attachment mechanism is disposed within a housing that encloses the processor and a portion of the conductivity sensor.

4. An apparatus as recited in claim 2, wherein the processor is coated with a material capable of preventing damage caused by proximity to the magnet.

5. An apparatus as recited in claim 4, wherein the material is a dielectric material.

6. An apparatus as recited in claim 2, wherein the apparatus has a length in the range of about four inches to twelve inches and a width in the range of about one half inch to two inches, whereby the apparatus is portable.

7. An apparatus as recited in claim 6, wherein the attachment mechanism is configured to have a gauss rating such that the attachment mechanism holds the apparatus in place when removably attached to a vertical metallic surface, and wherein the gauss rating of the attachment mechanism further allows the apparatus to be removed from the metallic surface without damaging the metallic surface.

8. An apparatus as recited in claim 1, further comprising a thermistor in electrical communication with the processor, wherein the thermistor provides a signal to the processor indicating a temperature of the liquid, and wherein the processor utilizes the signal to calibrate calculating the TDS level for the liquid.

9. A method for encouraging routine testing for TDS levels in a liquid, comprising the operations of:
determine a TDS level of a liquid utilizing an apparatus capable of determining a TDS level for the liquid based on a conductivity of the liquid;
performing corrective action to reduce the determined TDS level when the determined TDS level is beyond a predetermined level; and
facilitating a continual visual reminder for future TDS level testing by removably attaching the apparatus to a surface viewable when in proximity of a device utilized to access the liquid.

10. A method as recited in claim 9, wherein the apparatus is attached to the surface utilizing an attachment mechanism in the form of a magnet capable of removably attaching the apparatus to a metallic surface.

11. A method as recited in claim 10, wherein the surface is a surface of a refrigerator viewable when in proximity of a device utilized to access the liquid.

12. A method as recited in claim 10, wherein the surface is a surface of a water filtration system viewable when in proximity of a device utilized to access the liquid.

13. A method as recited in claim 9, wherein the corrective action is changing a filter of a water filtration system utilized to filter the liquid.

14. A method as recited in claim 13, further comprising the operations of:
determine TDS level of the liquid prior to filtration;
determine TDS level of the liquid subsequent to filtration; and
calculating an effectiveness of the filter based on the TDS level of the liquid prior to filtration and the TDS level of the liquid subsequent to filtration.

15. A total dissolved solids (TDS) meter for determining total dissolved solids in liquids, comprising:
a housing having a length in the range of about four inches to twelve inches and a width in the range of about one half inch to two inches;
a conductivity sensor disposed at least partially within the housing, the conductivity sensor capable of sensing a conductivity level of a liquid;
a processor disposed within the housing and in electrical communication with the conductivity sensor, the processor having logic that calculates a TDS level for the liquid based on the conductivity level of the liquid;
a display in electrical communication with the processor, the display capable of displaying the calculated TDS level for the liquid; and
an integrated attachment mechanism disposed within the housing, the integrated attachment mechanism capable of removably attaching the apparatus to a surface.

16. A TDS meter as recited in claim 15, wherein the attachment mechanism is a magnet capable of removably attaching the apparatus to a metallic surface.

17. A TDS meter as recited in claim 16, wherein the processor is coated with a material capable of preventing damage caused by proximity to the magnet.

18. A TDS meter as recited in claim 17, wherein the material is a dielectric material.

19. A TDS meter as recited in claim 17, wherein the attachment mechanism is configured to have a gauss rating such that the attachment mechanism holds the apparatus in place when removably attached to a vertical metallic surface.

20. A TDS meter as recited in claim 19, wherein the gauss rating of the attachment mechanism further allows the apparatus to be removed from the metallic surface without damaging the metallic surface.
